(19) United States
(12) Patent Application Publication
(10) Pub. No.: US 2026/0246139 A1
(43) Pub. Date: Aug. 20, 2026

(54) DISPLAY APPARATUS WITH TRANSPARENT RF ANTENNA LAYER

(71) Applicant: Visa International Service Association, San Francisco, CA (US)

(72) Inventors: Mustafa Top, San Ramon, CA (US); Yuexi Chen, Foster City, CA (US)

(73) Assignee: Visa International Service Association, San Francisco, CA (US)

(21) Appl. No.: 19/161,177

(22) PCT Filed: Mar. 1, 2024
(86) PCT No.: PCT/US2024/018054

§ 371 Date: Aug. 29, 2025

Related U.S. Application Data
(60) Provisional application No. 63/487,661, filed on Mar. 1, 2023.

(51) Int. Cl. H01Q 1/22; G02F 1/133; G06F 3/041; H04W 12/06

(52) U.S. Cl. CPC H01Q 1/2266; G02F 1/13306; H04W 12/06; G06F 3/0412

(57) ABSTRACT

A communication device, comprising: a processor; and a display apparatus coupled to the processor, wherein the display apparatus comprises a transparent top layer, an image layer proximate to the transparent top layer, and an antenna layer comprising a first RF antenna formed of a transparent conductive material proximate to the image layer for communicating with a user device comprising a second RF antenna.

### CROSS-REFERENCES TO RELATED APPLICATIONS

This application is a PCT application which claims priority to U.S. provisional application No. 63/487,661, filed on Mar. 1, 2023, which is herein incorporated by reference in its entirety

### BACKGROUND

Some communication devices have NFC (near field communication) readers with NFC antennas in them. The NFC readers can detect corresponding antennas in user devices such as cards. Some have proposed incorporating the NFC antennas within the display electronics of an image layer or in a touch screen sensing layer in a display apparatus.

While solutions such as these can appear to be effective, they may not be effective in practice. If NFC antennas are incorporated with other active electronic circuitry in the same layer, the size and/or configuration of the NFC antennas are constrained. It may not be possible to design the NFC antennas such that they can communicate with other NFC antennas in an optimal manner. Further, layers with NFC antennas and touch sensing circuitry or display circuitry are difficult to fabricate, due to the level of complexity of the integrated circuitry. Adding NFC antenna circuitry to such layers make those layers more complex and therefore more difficult to fabricate.

Embodiments of the disclosure address this problem and other problems individually and collectively.

### BRIEF SUMMARY

One embodiment of the invention includes a communication device comprising: a processor; and a display apparatus coupled to the processor, wherein the display apparatus comprises a transparent top layer, an image layer proximate to the transparent top layer, and an antenna layer comprising a first RF antenna formed of a transparent conductive material proximate to the image layer for communicating with a user device comprising a second RF antenna.

Another embodiment of the invention includes a system comprising: a communication device comprising a processor, and a display apparatus coupled to the processor, wherein the display apparatus comprises a transparent top layer, an image layer proximate to the transparent top layer, and an antenna layer comprising a first RF antenna formed of a transparent conductive material proximate to the image layer for communicating with a user device comprising a second RF antenna; and the user device.

Another embodiment of the invention includes method of using a communication device comprising a processor, and a display apparatus coupled to the processor, wherein the display apparatus comprises a transparent top layer, an image layer proximate to the transparent top layer, and an antenna layer comprising a first RF antenna formed of a transparent conductive material proximate to the image layer, and a network interface coupled to the processor. The method comprises: receiving, by the communication device from a user device via the first RF antenna and a second RF antenna in the user device, a credential; and transmitting, by the communication device, the credential to an external server computer, wherein the external server computer processes an interaction using the credential.

These and other embodiments of the invention are described in further detail below.

### BRIEF DESCRIPTION OF THE DRAWINGS

FIG. 1 shows a diagram of a system according to an embodiment.

FIG. 2 is a block diagram of some components in a communication device according to embodiments of the invention.

FIG. 3 shows a diagram showing a sequence of layers in a display apparatus including an OLED (organic light emitting diode) layer according to embodiments.

FIG. 4 shows some basic components in an OLED device.

FIG. 5 shows an electrical diagram with some components in an LCD (liquid crystal display) display apparatus.

FIG. 6 shows a cross-sectional view of an area of a display apparatus including a touch screen layer, an image layer that is an LCD image layer, and an antenna layer.

FIG. 7 shows a block diagram of another system according to an embodiment.

### DETAILED DESCRIPTION

Prior to discussing embodiments of the disclosure, some terms can be described in further detail.

A “user” may include an individual. In some embodiments, a user may be associated with one or more personal accounts and/or mobile devices. The user may also be referred to as a cardholder, account holder, or consumer in some embodiments.

A “user device” may be any suitable device that is operated by a user. Suitable user devices can be portable, and can communicate with external entities such as access devices. Examples of user devices include cards that data stored on them, mobile phones, laptop computers, transponders, wearable devices such as smart watches, automobiles with remote communication capabilities, access cards, smart media, etc. A payment device may be an example of a user device.

A “payment device” may refer to a device that may be used to conduct a financial transaction, such as to provide payment information to a merchant. A payment device may be in any suitable form. For example, suitable payment devices can be hand-held and compact so that they can fit into a consumer's wallet and/or pocket (e.g., pocket-sized). They may include smart cards, magnetic stripe cards, keychain devices, etc. If the payment device is in the form of a debit, credit, or smartcard, the payment device may also optionally have features such as magnetic stripes. Such devices can operate in either a contact or contactless mode.

A “communication device” may be a device that includes one or more electronic components (e.g., an integrated chip) that can communicate with another device. For example, a communication device can be a computing device that includes at least one processor coupled to a memory that stores instructions or code for execution by the processor. A “portable communication device” can be a communication device that can be transported and operated by a user. A portable communication device may provide remote communication capabilities to a network. A portable communication device can be configured to transmit and receive data or communications to and from other devices. A portable communication device may be in the form of a mobile device such as a mobile phone (e.g., smart phone, cellular phone, etc.), tablets, portable media player, personal digital assistant devices (PDAs), wearable computing device (e.g., watch), health monitoring device, electronic reader device, etc., or in the form of a card (e.g., smart card) or a fob, etc. Examples of portable communication devices may also include portable computing devices (e.g., laptops, netbooks, ultrabooks, etc.). A portable communication device may also be in the form of a vehicle (e.g., an automobile), or be integrated as part of a vehicle (e.g., an infosystem of a vehicle).

Embodiments of the invention can allow for an independent transparent antenna layer to be incorporated between other layers of a display apparatus in a communication device. The independent layer comprises a transparent RF antenna such as an NFC antenna which can provide for NFC communication at 13.56 MHz. In embodiments of the invention, the transparent RF antenna layer contains only RF antenna circuitry and no other active circuitry for other electronic devices. Some benefits of the using the transparent antenna layer includes the ability to design for larger antenna circuit traces, as well as freedom of design and shape.

The size and shape of an antenna can depend on properties such as the thickness of the path, the height of the conductive material, and the number of turns. Such properties depend on the material an antenna is made from, the requirements of the driver circuit defined by the manufacturer, and the relevant specifications (e.g., EMV contactless, NFC, ISO 14443).

In an embodiment, a transparent antenna is made from a transparent and conductive material (e.g., indium tin oxide (ITO), conductive polymers, etc.) as a separate layer between other layers of a display screen of a communication device. A benefit of such an embodiment allows for the freedom to design antennas smaller than the screen size, closer to the landing plane, etc. Embodiments of the invention further enable the distance between coupling devices (e.g., communication device and user device) to be reduced compared to the case where an antenna is under a display screen. Thus, embodiments described herein achieve improved RF communication (e.g., coupling) between NFC devices (e.g., communication devices and user devices).

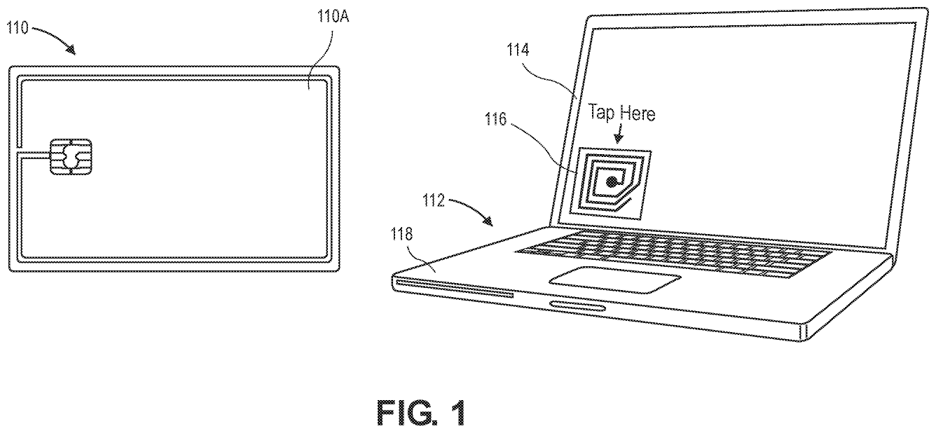

FIG. 1 shows a system according to an embodiment. The system includes a user device 110 comprising a second RF antenna 110A (e.g., a second NFC antenna). In some examples, the user device 110 can be in the form of a card. The system also includes a communication device 110, which can include a base portion 118 and a display apparatus 114 moveably connected to the base portion 118. The display apparatus 114 can display an area 116 which can correspond to the location of a first RF antenna inside of the display apparatus 114. The area 116 can have displayed in it an interaction indicator (e.g., a “tap here” icon) to guide the user operating the user device 110. The second RF antenna 110A and the first RF antenna can communicate when the user device 110 is manipulated so that it is proximate to the area 116.

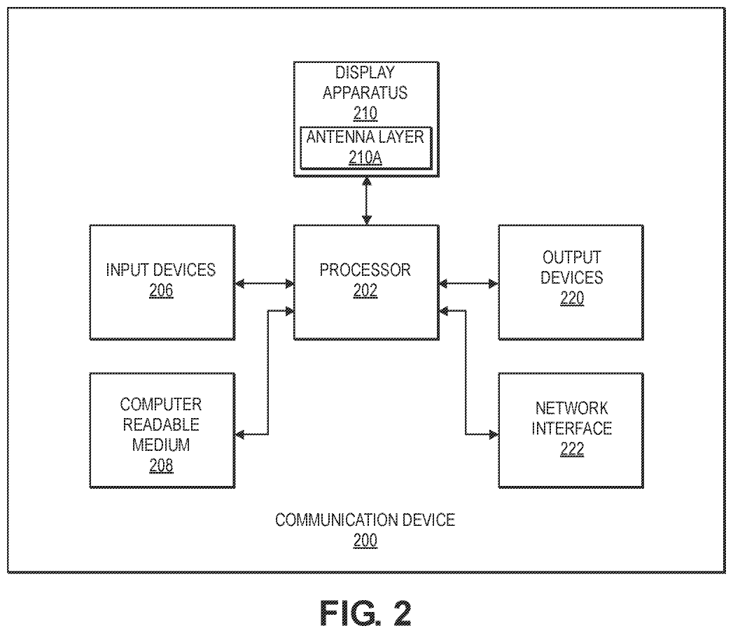

FIG. 2 shows a block diagram including some components in a communication device 200. The communication device 200 can include a processor 202, which is operatively coupled to input devices 206, a computer readable medium 208, input devices 206, a display apparatus 210 comprising an antenna layer 210A, output devices 220, and a network interface 222. One of more of the components in FIG. 2 can be present in a housing, such as a plastic housing.

The input devices 206 may be any device that accepts input from a user. Examples may include a keyboard, keypad, mouse, or microphone. In the case of a microphone, the microphone may be any device that converts sound to an electric signal. In some embodiments, the microphone may be used to capture voice data from a user.

The output devices 220 can include a speaker or any device that outputs sounds or other signals to a user. Examples may include a built-in speaker or any other device that produces sound in response to an electrical audio signal.

Computer-readable medium 208 may be any magnetic, electronic, optical, or other computer-readable storage medium. Computer-readable storage medium 208 may comprise any combination of volatile and/or non-volatile memory such as, for example, buffer memory, RAM, DRAM, ROM, flash, or any other suitable memory device, alone or in combination with other data storage devices. In some embodiments, computer readable medium is a non-transitory computer-readable medium that comprises code, for causing the processor 202 to perform a method comprising: receiving a credential from a user device via a first RF antenna and a second RF antenna; and transmitting the credential to an external server computer via the network interface. It may also have code, for causing an image layer to display an interaction indicator proximate to a location of the first RF antenna.

The network interface 222 may include an interface that can allow the communication device 200 to communicate with external computers. Some examples of the network interface 222 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 222 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

Embodiments of the invention can be used with liquid crystal displays, OLED displays or other types of displays. Further details regarding LCDs and OLEDs can be found in U.S. Pat. Nos. 9,348,488, 9,046,955, and 11,005,180, which are herein incorporated by reference.

A display such as a liquid crystal display may include a touch screen function that allows inputting users' commands by selecting the instructions on the screen with fingers or objects. Touch screen panels are input devices that may allow for selection of contents displayed on the screen of an image display device, etc. using a person's hand or an object to input commands of a user.

The touch screen panels may be provided on a front face of the image display device and may convert positions where a person's hand or an object directly contacts into electrical signals. Accordingly, the instruction selected at the contact point is received as an input signal. The touch screen panels may be a substitute for separate input devices that are operated by being connected with the image display device such as a keyboard and a mouse.

Types of touch screen panels include, e.g., an ohmic layer type, a photosensitive type, and capacitive type. A capacitive type of touch screen panel may convert a contact position into an electrical signal by, e.g., a conductive sensing pattern that senses a change in electrostatic capacitance formed with another sensing pattern around or a grounding electrode, when a person's hand or an object contacts the panel.

A liquid-crystal display (LCD) is a flat-panel display or other electronically modulated optical device that uses the light-modulating properties of liquid crystals combined with polarizers. Liquid crystals do not emit light directly but instead use a backlight or reflector to produce images in color or monochrome.

Unlike an LCD display, an organic light emitting diode (OLED) does not require a backlight, and is formed by depositing the organic thin film between the upper metal cathode and the bottom transparent anode. The OLED is manufactured on the transparent substrate, e.g., the glass, and the transparent anode is made of the transparent conductor such as the indium tin oxide (ITO).

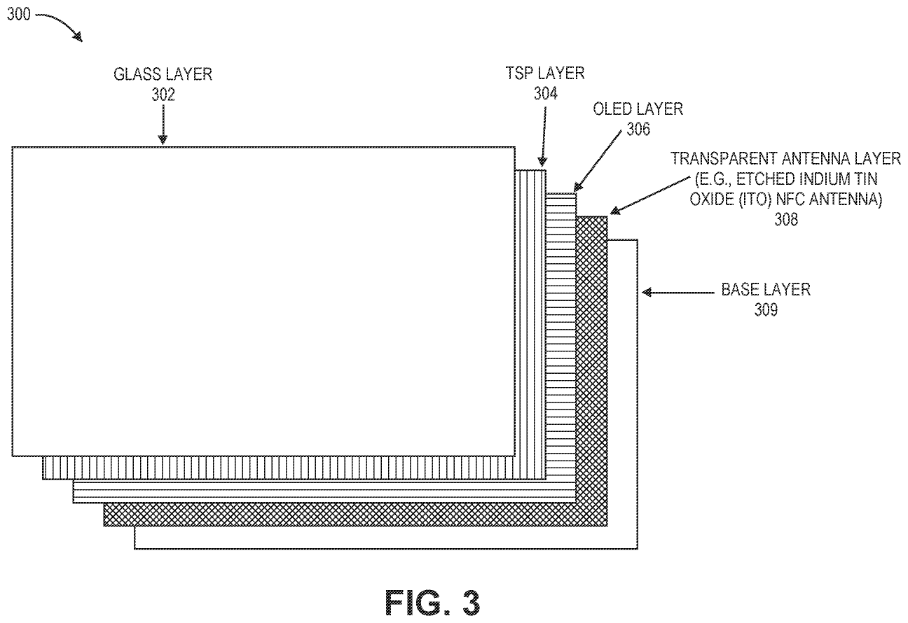

FIG. 3 illustrates some components of a display apparatus that utilizes a transparent antenna. The display apparatus 300 can be in a communication device. The display apparatus 300 can comprise a glass layer 302 (an example of a transparent top layer), a touch screen panel (TSP) layer 304, an OLED layer 306 (an example of an image layer), a transparent antenna layer (e.g., etched indium tin oxide (ITO) NFC antenna ) 308, and a base layer 309. The OLED layer 306 can contain the materials and electronics to produce images. The base layer 309 can be a supporting layer and can be rigid. The transparent antenna layer 308 can include an etched ITO NFC antenna on an insulating substrate. Although the transparent antenna layer 308 is shown to be behind or below the TSP layer 304 in apparatus 300, the transparent antenna layer 308 could alternatively be positioned in front of or above the TSP layer 304. As shown, the layers 302, 304, 306, 308, and 309 are proximate to each other. The transparent antenna layer 308 can be pre-formed, and then assembled with the other layers in FIG. 3.

In embodiments, the transparent antenna layer can include one or more short range antennas (NFC antennas) that can receive data from an interaction with a user device. In some embodiments, the user can tap a user device near the antenna, and data from the user device can be received by the processor in the communication device via the antenna. Because the circuits defining the one or more antennas in the antenna layer are transparent, it is possible to arrange the antennas at any desired locations. In some cases, a sufficient number of antennas can be added such that a user may be asked to tap a user device against any area on the display screen, and not just a specific area on the communication device.

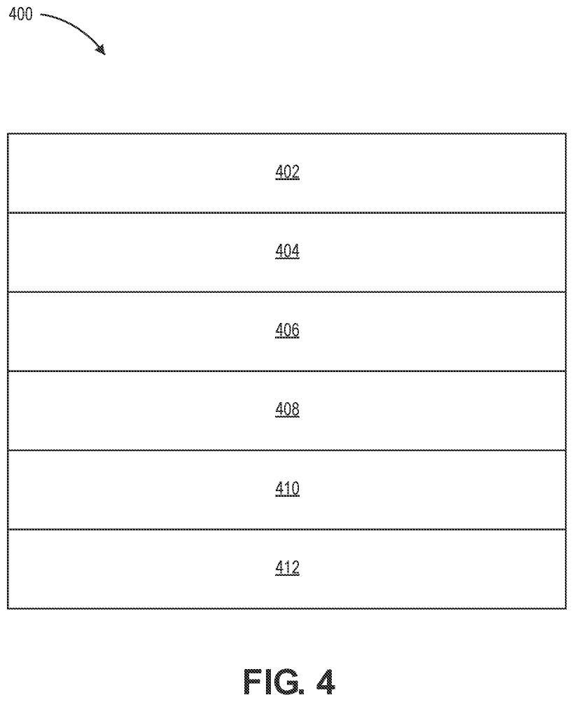

FIG. 4 shows a schematic diagram of an OLED structure 400 that can incorporate the transparent antenna layer 410. The OLED structure can include a substrate 412 which supports the transparent antenna layer 410. The functional components of the OLED structure 400 including a cathode layer 402 comprising cathodes, an emissive layer (e.g., emissive organic molecules or polymers) 404, a conducting layer (e.g., conducting organic molecules or polymers) 406, and an anode layer 408 comprising anodes can lie on top of the transparent antenna layer 410. The transparent antenna layer 410 can comprise RF antennas that are coupled to a processor, which can also communicate with the anodes in the anode layer 408 and the cathodes in the cathode layer 402.

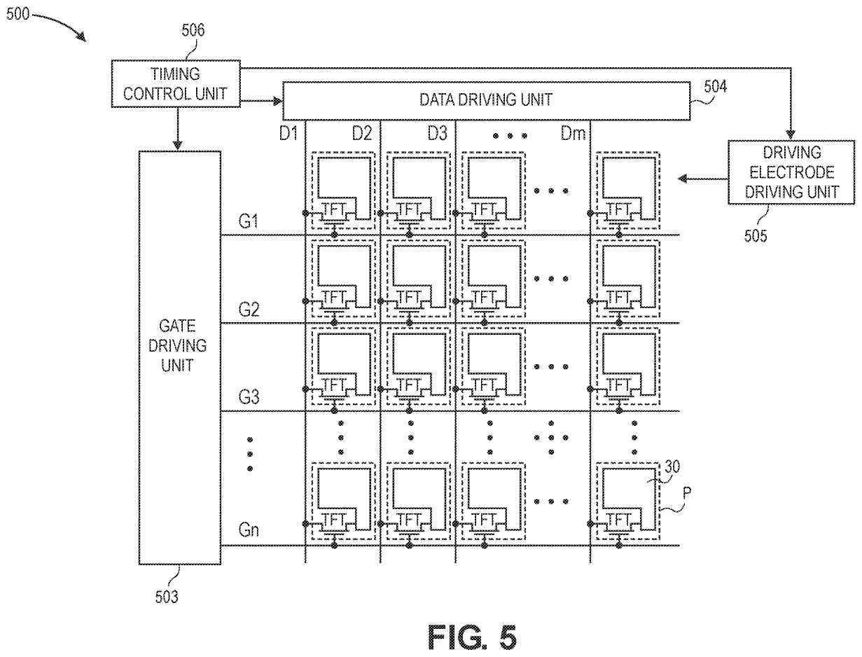

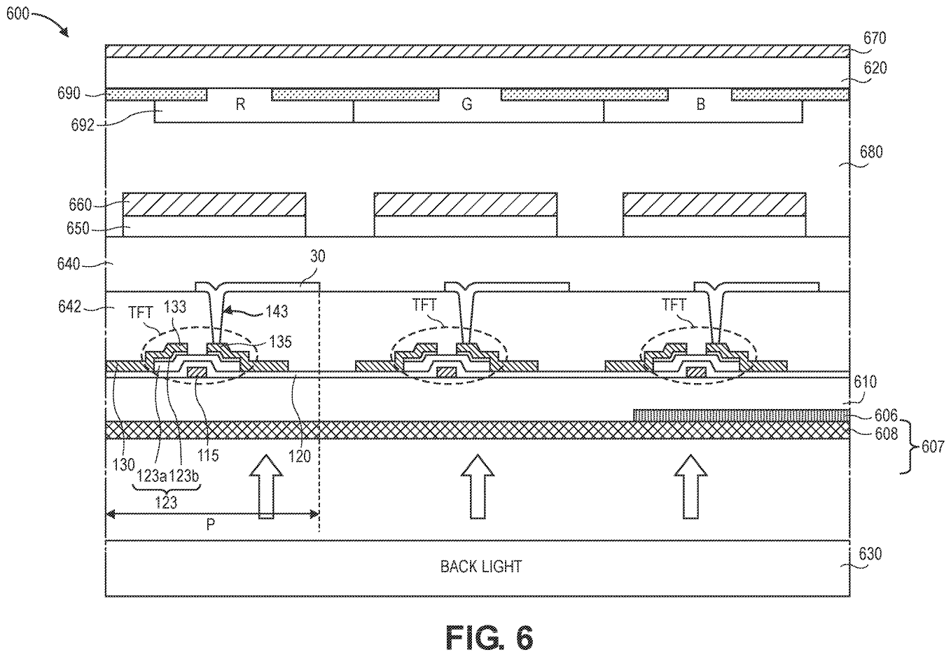

FIG. 5 illustrates a block diagram showing electrical components of a a display having a liquid crystal display with an integrated touch screen panel. FIG. 6 illustrates a cross-sectional view showing an area of the display including the liquid crystal display with an integrated touch screen panel, and a separate transparent antenna layer, according to an embodiment.

A liquid crystal display with an integrated touch screen panel 600, according to an exemplary embodiment, may include a first substrate 610 and a second substrate 620. Between the first and second substrates 610 and 620 may be an insulating layer 640, a plurality of transparent electrodes 650, a plurality of metal electrodes 660, a plurality of sensing electrodes 670, and a liquid crystal layer 680. The combination of the layers may form an image layer as they contain sufficient components to form an image. The first substrate 610 may be an array substrate, on which gate wires G1 to Gn and data wires D1 to Dm may be arranged to intersect each other. A plurality of pixels P, e.g., each including a thin film transistor TFT and a pixel electrode 30, may be disposed on the first substrate 610. A backlight 630 provides light to display an image may be disposed under the first substrate 610. A transparent top layer (not shown) can be over the layer including the sensing electrodes 670.

The second substrate 620 may be a color filter substrate, opposite to the first substrate 610. A black matrix 690 may have a lattice shape surrounding the pixels P to cover the non-display area, such as the gate wires G1 to Gn, the data wires D1 to Dm, and the thin film transistors TFT. Color filter patterns 692 of red R, green G, and blue B may be sequentially and repeatedly arranged to correspond to the pixels P in the black matrix 690 on the bottom of the second substrate 620. The first substrate 610 and the second substrate 620 may be transparent substrates and may be made of insulating material, such as glass, plastic, silicon, or synthetic resin.

The plurality of sensing electrodes 670 may be arranged at a predetermined distance from each other in the second direction interesting the first direction, on the top of the second substrate 620. The sensing electrodes 670 may be made of a transparent conductive material, e.g., ITO.

A transparent antenna layer 607 can comprise a transparent substrate 608 and transparent conductors 606. The transparent conductors 606 can form circuit traces that form the first RF antenna(s) in the transparent antenna layer 607. As shown, the transparent antenna layer 607 can contain only antenna circuitry for RF antennas (e.g., NFC antennas), and can be preformed. It can then be attached (e.g., with glue) to the other layers or devices such as the backlight 630 shown in FIG. 6.

The substrate 608 can be, for example, formed of a transparent glass containing SiO₂ as a main component, but the present invention is not limited thereto, and thus the substrate 608 may also be formed of a transparent plastic material that may be an insulating organic material selected from the group consisting of polyethersulphone (PES), polyacrylate (PAR), polyetherimide (PEI), polyethyelene napthalate (PEN), polyethyelene terephthalate (PET), polyphenylene sulfide (PPS), polyallylate, polyimide, polycarbonate (PC), triacetate cellulose (TAC), and cellulose acetate propionate (CAP). In some embodiments, the substrate 608 can also be made of a clear, insulating, and flexible material.

The transparent conductors 606 can be formed or a transparent conductive material such as ITO, IZO, ZnO, and/or In₂O₃. The transparent conductors 406 can form the coils in the RF antennas and can include circuit traces leading to any controllers or processors that can process signals from the RF antennas or provide signals to the RF antennas.

Referring to FIG. 6, the thin film transistor TFT may include a gate electrode 115 connected with a gate line, a first electrode 133 (e.g., a source electrode), a second electrode 135 (e.g., a drain electrode), and a semiconductor layer 123 between the gate electrode 115 and the first and second electrodes 133 and 135. The semiconductor layer 123 may include an active layer 123a and an ohmic contact layer 123b. A gate insulating layer 120 may be on the gate electrode 115, a passivation layer 642 may be on and in between the first and second electrodes 133 and 135. The passivation layer 642 may have a contact hole 143 exposing the second electrode 135. The pixel electrode 30 may be on the passivation layer 642 and may be connected with the second

electrode 135 through the contact hole 143. The image display operation of the liquid crystal display with an integrated touch screen panel having the structure described above is simply described below. First, when a gate signal is transmitted to the gate electrode 115 of the thin film transistor TFT in the pixel P, the active layer 123a may be activated and the first electrode 133 may transmit the data signal transmitted from the data wire 130 connected with the first electrode 133 to the second electrode 135 at a predetermined distance through the active layer 123 thereunder.

Since the second electrode 135 may be electrically connected with the pixel electrode 30 through the contact hole 143, the voltage of the data signal may be applied to the pixel electrode 30. Therefore, the liquid crystal molecules in the liquid crystal layer 680 may be rearranged by the voltage corresponding to a difference between the voltage applied to the pixel electrode 30 and the voltage applied to the metal electrode 60, such that a predetermined image is displayed.

The insulating layer 640 may be on the pixel electrode 30. The transparent electrodes 650 and the metal electrodes 660 may be on the insulating layer 40. For example, when the transparent electrodes 650 may be patterned first on, e.g., directly on, the insulating layer 640 and the metal electrodes 660 may be formed on the transparent electrodes 650.

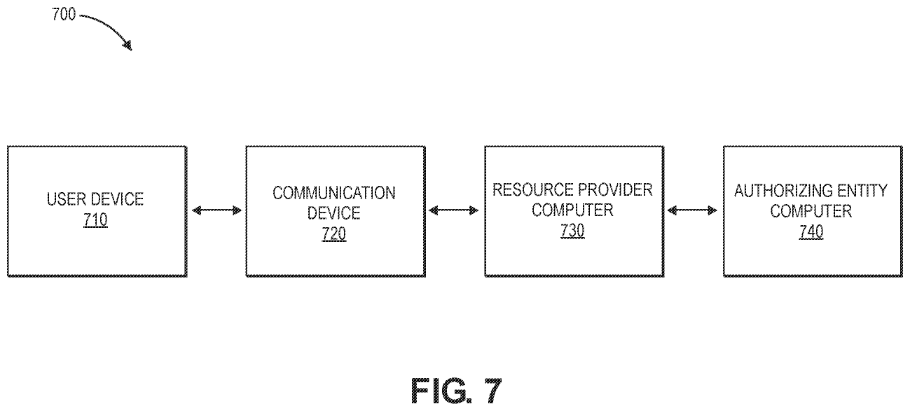

FIG. 7 shows a block diagram of a system in which the communication device with the transparent antenna layer can be used. The system includes a user device 710 and a communication device 720, which can communicate with each other as described above. The communication device 720 can be in communication with a resource provider computer 730, which is in turn in communication with an authorizing entity computer 740 (e.g., an issuer computer). In some embodiments, a transport computer (e.g., an acquirer computer) and a processing network computer in a processing network (e.g., a payment processing network) can be between (e.g., in an operational sense) the resource provider computer 730 and the authorizing entity computer 740.

The user device 710 can be place proximate to a landing area in a display apparatus of the communication device 720 as described above. A credential can be read from user device 710 via a second RF antenna therein and a first RF antenna in a transparent antenna layer in the display apparatus in the communication device 720. A processor in the communication device 720 can receive the credential and can transmit it to the resource provider computer 730. The resource provider computer 730 can generate and transmit an authorization request message including a transaction amount to the authorizing entity computer 740 for authorization. The authorizing entity computer 740 can respond to the resource provider with an authorization response message approving or declining the transaction.

Embodiments of invention have a number of technical advantages. For example, embodiments of the invention can provide for a separate, transparent antenna layer in a display device. It can be pre-formed with RF antennas of any desired configuration (e.g., an array of antennas) and/or location in the transparent antenna layer. It can later be assembled with display electronics, and the antennas are not constrained by active circuitry used for other functions.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A communication device comprising:
a processor; and
a display apparatus coupled to the processor, wherein the display apparatus comprises
a transparent top layer,
an image layer proximate to the transparent top layer, and
an antenna layer comprising a first RF antenna formed of a transparent conductive material proximate to the image layer for communicating with a user device comprising a second RF antenna.

2. The communication device of claim 1, wherein the transparent conductive material comprises indium tin oxide (ITO).

3. The communication device of claim 1, wherein the image layer in an OLED layer or an LCD layer.

4. The communication device of claim 1, wherein the communication device is a laptop computer or a tablet computer.

5. The communication device of claim 1, wherein the communication device further comprises a non-transitory computer readable medium coupled to the processor, the non-transitory computer readable medium comprising code, for causing the image layer to display an interaction indicator proximate to a location of the first RF antenna.

6. The communication device of claim 1, wherein the antenna layer is under the image layer.

7. The communication device of claim 1, further comprising:
a housing, wherein the processor is in the housing.

8. The communication device of claim 1, wherein the first RF antenna is a first NFC antenna.

9. The communication device of claim 1, wherein the display apparatus further comprises a sensing layer for sensing a pointer at an arbitrary location on a major surface of the display apparatus.

10. The communication device of claim 1, further comprising a backlight element, the antenna layer being between the backlight element and the transparent top layer.

11. The communication device of claim 1, further comprising a network interface coupled to the processor and a non-transitory computer readable medium coupled to the processor, wherein the non-transitory computer readable medium comprises code, for causing the processor to perform a method comprising:
receiving a credential from the user device via the first RF antenna and the second RF antenna; and
transmitting the credential to an external server computer via the network interface.

12. A system comprising:
a communication device comprising a processor, and
a display apparatus coupled to the processor, wherein the display apparatus comprises
a transparent top layer,
an image layer proximate to the transparent top layer, and
an antenna layer comprising a first RF antenna formed of a transparent conductive material proximate to the image layer for communicating with a user device comprising a second RF antenna; and
the user device.

13. The system of claim 12, wherein the user device is comprises a credential, wherein the credential is received by the second RF antenna via the first RF antenna.

14. The system of claim 13, wherein the user device is in the form of a card.

15. A method of using a communication device comprising a processor, and a display apparatus coupled to the processor, wherein the display apparatus comprises a transparent top layer, an image layer proximate to the transparent top layer, and an antenna layer comprising a first RF antenna formed of a transparent conductive material proximate to the image layer, and a network interface coupled to the processor, the method comprising:
receiving, by the communication device from a user device via the first RF antenna and a second RF antenna in the user device, a credential; and
transmitting, by the communication device, the credential to an external server computer, wherein the external server computer processes an interaction using the credential.

16. The method of claim 15, wherein the user device is in the form of a card.

17. The method of claim 15, further comprising:
displaying using the image layer an interaction indicator proximate to a location of the first RF antenna.

18. The method of claim 17, wherein the image layer comprises an LCD layer or an OLED layer.

19. The method of claim 15, wherein the communication device is a laptop computer.

20. The method of claim 15, wherein the first RF antenna is a first NFC antenna and the second RF antenna is a second NFC antenna.
